(19) United States
(12) Patent Application Publication
(10) Pub. No.: US 2018/0126882 A1
(43) Pub. Date: May 10, 2018

(54) VEHICLE SEAT

(71) Applicant: TS TECH CO., LTD., Asaka-shi, Saitama (JP)

(72) Inventor: Atsushi OKIMURA, Shioya-gun, Tochigi (JP)

(21) Appl. No.: 15/561,898

(22) PCT Filed: Jul. 21, 2016
(86) PCT No.: PCT/JP2016/071353

§ 371 Date: Sep. 26, 2017

(30) Foreign Application Priority Data
Aug. 4, 2015 (JP) 2015-154038

(51) Int. Cl. B60N 2/66; B60N 2/68

(52) U.S. Cl. CPC B60N 2/6673; B60N 2/682

(57) ABSTRACT

A vehicle seat includes seat back frame; and pressure-receiving member supported by the seat back frame. The pressure-receiving member includes pressure-receiving plate configured to receive load from back of an occupant. The seat back frame includes support hole disposed at an upper part of the seat back frame and extending through in upper-lower direction, and engagement portion disposed at a lower part of the seat back frame. The pressure-receiving member includes pressure-receiving member body including the pressure-receiving plate, upper restriction portion disposed at an upper part of the pressure-receiving member body and inserted through the support hole to restrict front-rear and lateral positions of upper portion of the pressure-receiving member body, and lower restriction portion disposed at a lower part of the pressure-receiving member body and engaged with the engagement portion to restrict upper-lower and lateral positions of a lower portion of the pressure-receiving member body.

### TECHNICAL FIELD

The present invention relates to a vehicle seat including a pressure-receiving member disposed in a seat back.

### BACKGROUND ART

Conventionally, there is known a car seat of which a seat back includes a pressure-receiving member having a pressure-receiving plate configured to receive a load from the back of an occupant (PTL1 and PTL2). In these seats, the pressure-receiving member is stretched between and supported by side frames of a seat back frame that are spaced apart laterally to right and left sides.

### CITATION LIST

### Patent Literature

PTL1: Japanese translation of PCT International Application Publication No. 2009-502381

PTL2: Japanese Laid-open Patent Application Publication No. 2015-110427

### SUMMARY OF THE INVENTION

In recent years, the vehicle seat is provided with a lot of equipment, such as to cause an occupant to feel comfortable and to improve safety. For this reason, it is desired to provide excellent workability for attaching a lot of parts. It is also desired to provide excellent space efficiency in the seat.

In view of the above background of the art, it is an object of the present invention to provide a vehicle seat in which workability for attaching the pressure-receiving member is excellent.

It is also an object of the present invention to provide a space-efficient structure for allowing the pressure-receiving member to be supported by the seat back frame in the seat.

The present invention proposed to attain one or more of the above objects provides a vehicle seat comprising a seat back frame and a pressure-receiving member supported by the seat back frame, the pressure-receiving member including a pressure-receiving plate configured to receive a load from a back of an occupant. In this vehicle seat, the seat back frame includes a support hole disposed at an upper part of the seat back frame and extending through in an upper-lower direction, and an engagement portion disposed at a lower part of the seat back frame. The pressure-receiving member includes a pressure-receiving member body including the pressure-receiving plate, an upper restriction portion disposed at an upper part of the pressure-receiving member body and inserted through the support hole to restrict a front-rear position and a lateral position of an upper portion of the pressure-receiving member body, and a lower restriction portion disposed at a lower part of the pressure-receiving member body and engaged with the engagement portion to restrict an upper-lower position and a lateral position of a lower portion of the pressure-receiving member body.

With this configuration, the upper restriction portion is inserted through the support hole of the seat back frame and thereafter the lower restriction portion is engaged with the engagement portion, so that the front-rear position and the lateral position of the pressure-receiving member body are restricted and the upper-lower position and the lateral position of the pressure-receiving member body are restricted. Accordingly, assembly of the pressure-receiving member with the seat back frame and positioning of the pressure-receiving member can be performed in a simple manner, and thus the workability for attaching the pressure-receiving member can be improved.

In the above vehicle seat, the seat back frame may include side frames spaced apart from each other in a lateral direction, and a connecting member connecting lower portions of the side frames. It is desirable that the engagement portion is disposed in the connecting member. Further, the seat back frame may include a bridge member connecting upper portions of the side frames. In this case, it is desirable that the support hole is formed in the bridge member.

With this configuration, since the pressure-receiving member is supported by a member connecting the right and left side frames, other parts can be attached to the side frames, so that improved space efficiency is ensured.

In the above vehicle seat, the engagement portion may be a through-hole formed in the seat back frame and extending though the seat back frame in a front-rear direction, and the lower restriction portion may be a projection engageable with the through-hole.

With this configuration, the pressure-receiving member can be assembled with the seat back frame in a simple manner by engaging the projection in the through-hole.

In the above vehicle seat, it is desirable that the engagement portion is provided at plural positions, and a plurality of engagement portions are spaced apart from one another, and that the lower restricting portion is provided at plural positions corresponding to the plurality of engagement portions, and a plurality of lower restricting portions are spaced apart from one another.

Since the plurality of lower restricting portions are spaced apart in this way, the pressure-receiving member can be made stable after the pressure-receiving member is attached to the seat back frame.

It is preferable that the above vehicle seat further comprises a fixing member configured to fix the lower part of the pressure-receiving member body to the lower part of the seat back frame.

The lower part of the pressure-receiving member body is attached to the lower part of the seat back frame using the fixing member, so that the pressure-receiving member can be fixed firmly to the seat back frame.

The fixing member may be engaged with the seat back frame and the pressure-receiving member from a direction opposite to a direction in which the lower restriction portion enters the engagement portion.

By engaging the fixing member with the seat back frame and the pressure-receiving member from the direction opposite to the direction in which the lower restriction portion enters the engagement portion, attachment of the fixing member can be performed while an assembly worker is checking an engagement state of the lower restriction portion and the engagement portion.

The fixing member may be disposed below the lower restriction portion.

Further, the pressure-receiving plate may include a central portion, and a pair of side portions disposed on both right and left sides of the central portion and protruding frontward farther than the central portion, and in this case, the lower restriction portion may be disposed at a rear side of the central portion.

It is preferable that the lower restriction portion in the form of a projection includes at a distal end thereof a large-diameter portion having a diameter larger than that of a base portion, and that the large-diameter portion is engaged with an edge of the through-hole.

With this configuration, the projection is less likely to be come off the through-hole after the projection is brought into engagement with the through-hole to engage the large-diameter portion with the edge of the through-hole, so that the assembling workability of the pressure-receiving member can be improved.

### BRIEF DESCRIPTION OF DRAWINGS

FIG. 1 is a perspective view of a seat frame.

FIG. 2 is a perspective view illustrating a pressure-receiving plate and a support frame removed from the seat frame.

FIG. 3 is a rear view of the support frame.

FIG. 4 is views explaining the operation of the support frame, in which (a) shows a state in which an upper lifting plate and a lower lifting plate as a whole have been moved upward, and (b) shows a state in which the upper lifting plate has been moved downward.

FIG. 5 is a perspective view showing a state in which the upper lifting plate has been moved downward to cause arching members to protrude frontward.

FIG. 6 is a perspective view explaining the operation for inserting an upper restriction portion of a lumbar support device through support holes.

FIG. 7 is a perspective view explaining the operation for engaging a lower restriction portion with a lower frame and thereafter fixing them with screws.

FIG. 8 is a sectional view showing a modified embodiment of a projection, in which the lumbar support device has been temporarily assembled with the seat back frame.

### DESCRIPTION OF EMBODIMENTS

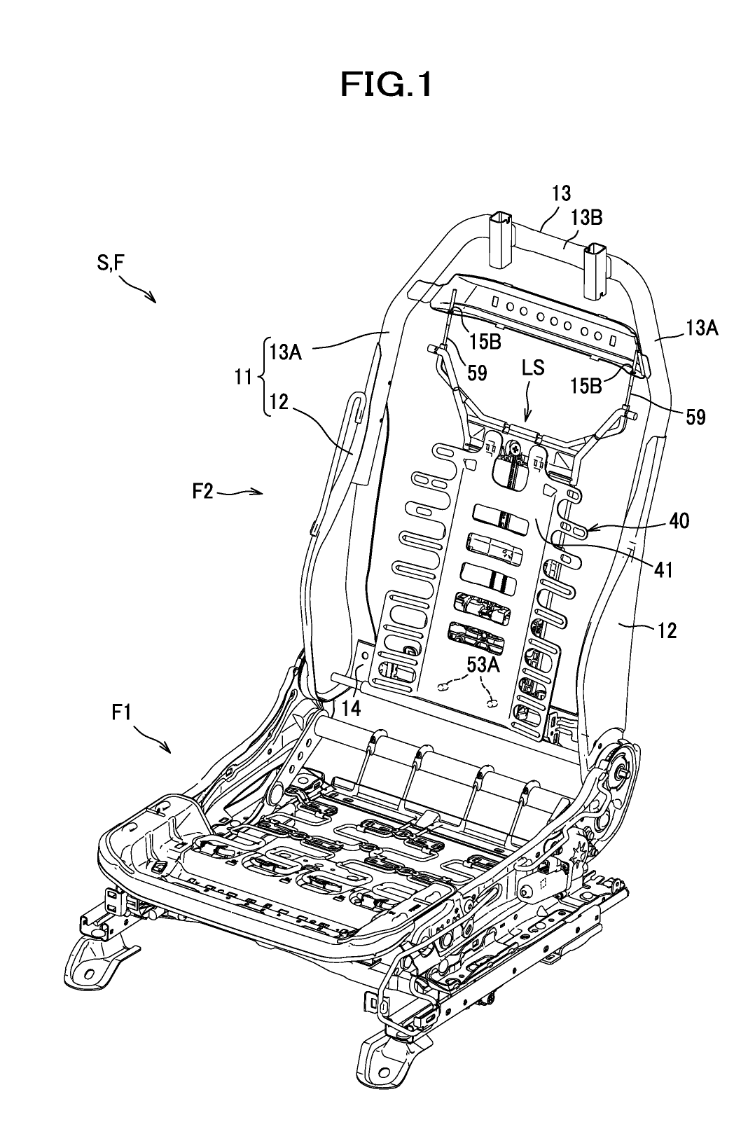

One embodiment of the present invention will be described in detail with reference made to the drawings, where necessary. As seen in FIG. 1, a car seat S as an example of a vehicle seat is configured as a seat installed in a car. As known in the art, a seat frame F shown in the drawings is upholstered with a cushion material (not shown) to provide the car seat S. The seat frame F includes a seat cushion frame F1 and a seat back frame F2, and the seat back frame F2 is connected to a rear end portion of the seat cushion frame F1 through a reclining mechanism. In the following description, front/rear (frontward/rearward), right/left (lateral), and upper/lower (upward/downward or vertical) directions are designated as from the view point of an occupant seated on the car seat S.

The seat back frame F2 supports a lumbar support device LS as an example of a pressure-receiving member.

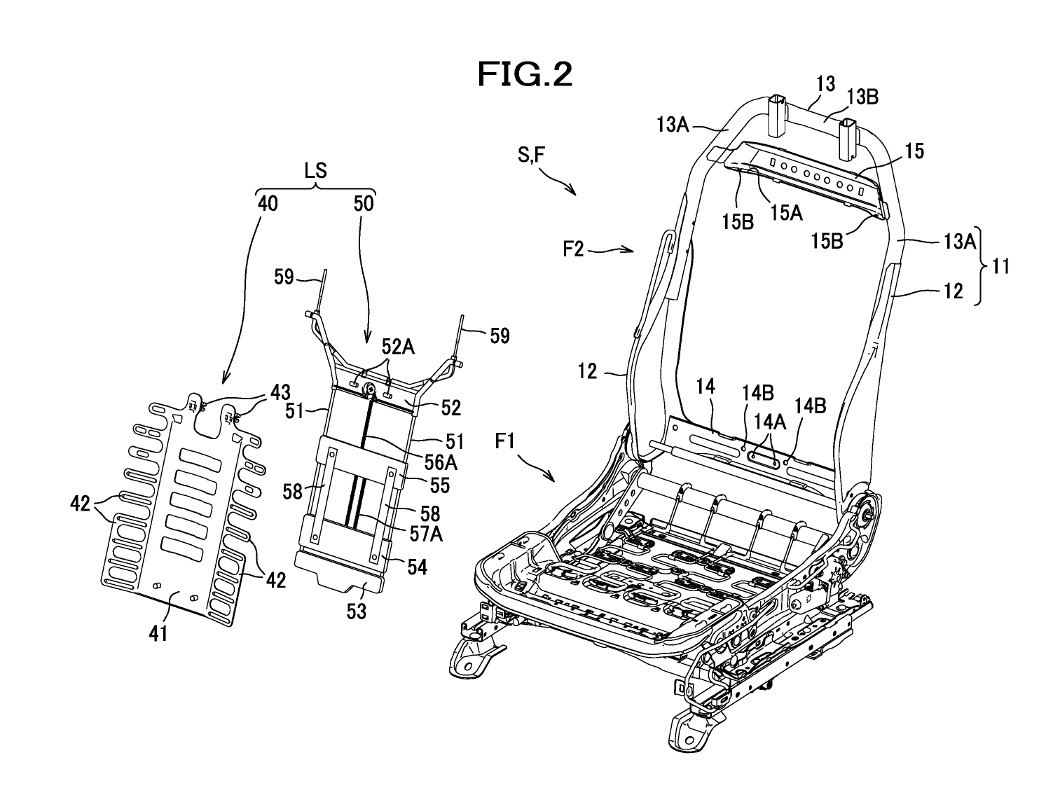

As seen in FIG. 2, the seat back frame F2 includes a pair of sheet metal frames 12 laterally spaced apart from each other, and a pipe frame 13 made by bending a pipe member into a U-shaped configuration and connected to respective upper ends of the pair of sheet metal frames 12.

The pipe frame 13 includes a pair of right and left upper side frames 13A each extending upward from the sheet metal frame 12 and then slightly slanted inward in the lateral direction. The right and left sheet metal frames 12 and the right and left upper side frames 13A constitute a pair of side frames 11 laterally spaced apart from each other. Further, the pipe frame 13 includes an upper frame 13B connecting upper end portions of the pair of upper side frames 13A, namely upper end portions of the side frames 11.

Further, the seat back frame F2 includes a lower frame 14 (as an example of a connecting member) connecting lower portions of the side frames 11, more specifically, lower portions of the sheet metal frames 12, and a bridge frame 15 (as an example of a bridge member) connecting upper end portions of the side frames 11, more specifically, the right and left upper side frames 13A, at a position below the upper frame 13B.

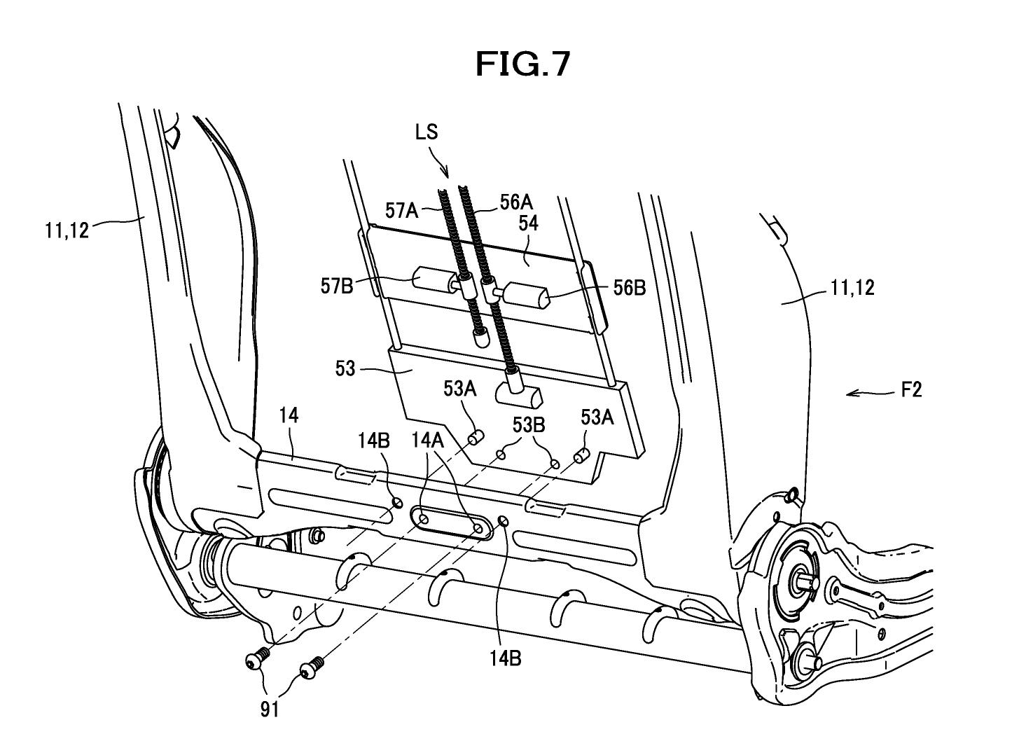

The lower frame 14 is made of a sheet metal and having a cross-sectional shape in which upper and lower edges thereof extend slightly frontward. The lower frame 14 extends long in the lateral direction, and a right end portion and a left end portion thereof are fixed by welding to inner extension portions (i.e., portions extending laterally inward) of the sheet metal frames 12. Two attachment holes 14A are formed in a central portion of the lower frame 14 (lower portion of the seat back frame F2); the two attachment holes 14A are slightly spaced apart in the lateral direction. The lower frame 14 faces in the front-rear direction when the seat back frame F2 is in the normal position where the seat back frame F2 is not being reclined, and the attachment holes 14A extend through the lower frame 14 in the front-rear direction. Each of the attachment holes 14A is a portion into which a screw 91 (see FIG. 7) as an example of a fixing member is inserted. The lower frame 14 further includes two through-holes 14B as an example of an engagement portion; the two through-holes 14B are formed in the lower frame 14 at positions slightly above and on right and left sides of the attachment holes 14A. The through-holes 14B extend through the lower frame 14 in the front-rear direction, and projections 53A to be described later (see FIG. 7) are insertable into and engaged with the through-holes 14B.

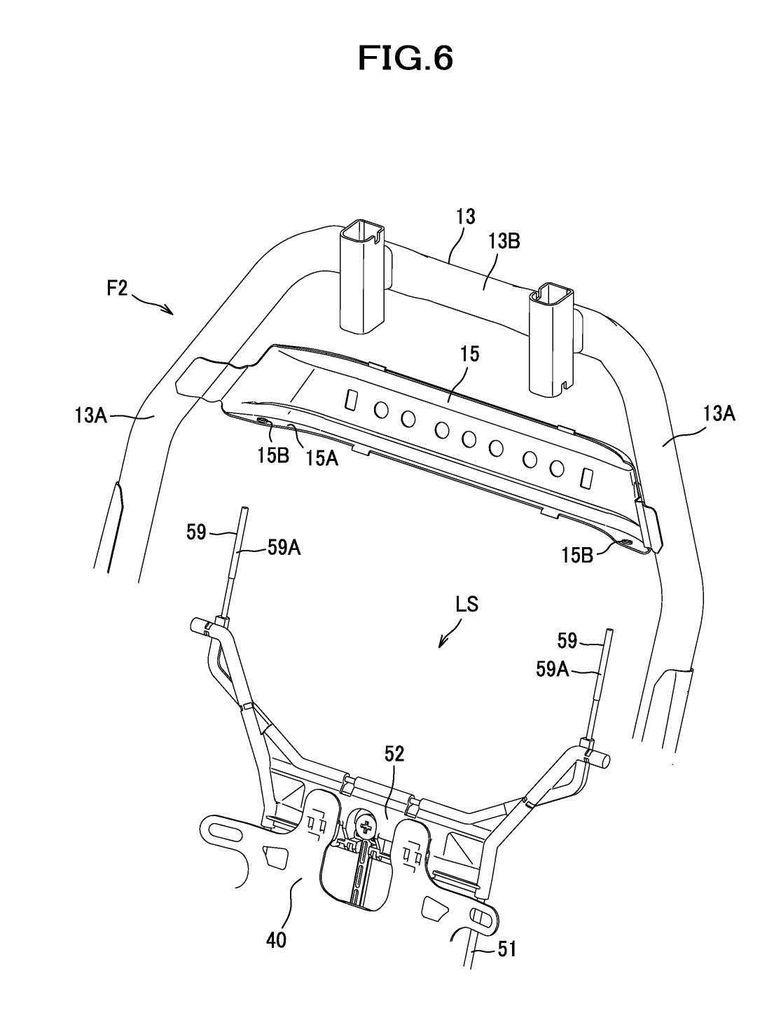

The bridge frame 15 has a lower edge at which a lower flange 15A extending frontward is formed (see FIG. 6). Support holes 15B extending through the lower flange 15A in the upper-lower direction are formed in the lower flange 15A.

The lumbar support device LS is a device configured to receive a force generated when the occupant learns against the seat back and to transmit the force to the seat back frame F2. The lumbar support device LS also changes the shape of a portion of the seat back on which the lumbar region of the occupant abuts so that the lumbar region can be supported differently in accordance with the preference of the occupant.

The lumbar support device LS includes a pressure-receiving plate 40 configured to receive a load applied from the back of the occupant through a cushion material (not shown), and a support member 50 configured to support the pressure-receiving plate 40 and to cause the pressure-receiving plate 40 to change its shape.

The pressure-receiving plate 40 is a plate member made of plastic or the like, and includes a central portion 41 located directly behind the back of the occupant, and a pair of side portions 42 disposed on both sides of the central portion 41 and protruding frontward farther than the central portion 41. The side portions 42 are disposed to support right and left sides of the back of the occupant. Each side portion 42 includes a plurality of narrow plate members extending obliquely frontward and deflectable to an adequate extent to gently receive the side of the back of the occupant. It is to be noted that the four narrow plate members disposed at the lower side of the side portion 42 are connected together at their distal ends, so that the rigidity of the four narrow plate members is slightly higher than that of the other five narrow plate members disposed above the four narrow plate members.

Two attachment hooks 43 are laterally arranged at an upper part of the rear surface of the pressure-receiving plate 40. Each of the attachment hooks 43 has a C-shaped configuration as viewed from the lateral direction; the attachment hook 43 opens rearward.

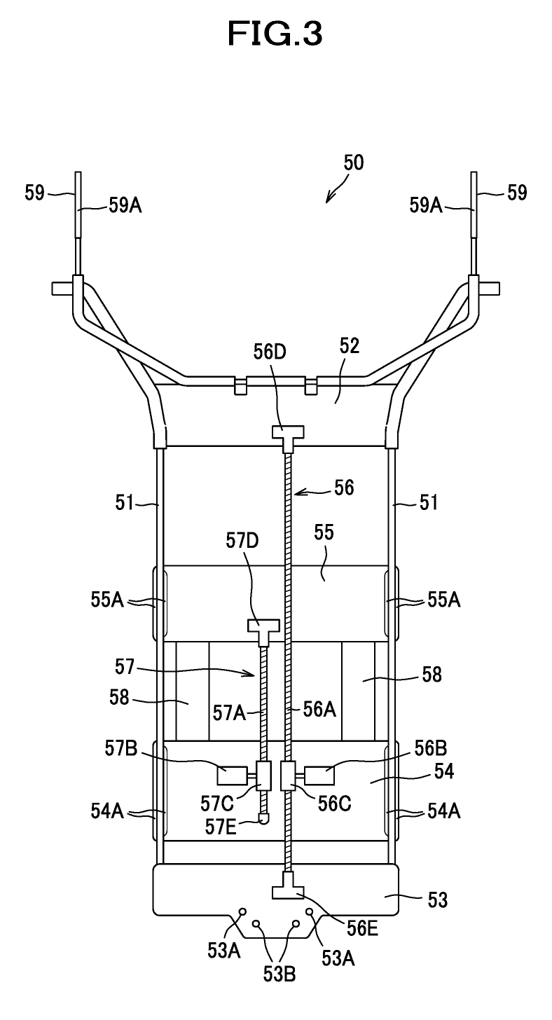

The support member 50 includes guide wires 51, an upper connecting portion 52, a lower connecting portion 53, a lower lifting plate 54, an upper lifting plate 55, a support portion lifting mechanism 56 (see FIG. 3), an arch deformation mechanism 57 (see FIG. 3), arching members 58, and support wires 59 as an example of an upper restriction portion.

The guide wires 51 are wires extending long in the upper-lower direction; two guide wires 51 are spaced apart in the lateral direction and disposed parallel to each other. Although not shown in the drawings, the two guide wires 51 are connected together in the lower connecting portion 53 to form a single U-shaped wire as a whole.

The upper connecting portion 52 is a portion connecting upper portions of the two guide wires 51. The upper connecting portion 52 is made of plastic; the upper connecting portion 52 is produced through insert molding process, by which the guide wires 51 are integrated in the upper connecting portion 52. Provided on the front surface of the upper connecting portion 52 are two cylindrical support projections 52A that are arranged side by side with their axes extending in the lateral direction. The support projections 52A are disposed at positions corresponding to the two attachment hooks 43, and the attachment hooks 43 are engaged onto the support projections 52A so that the pressure-receiving plate 40 is rotatably supported by the support projections 52A.

The lower connecting portion 53 is a portion configured to connect the lower portions of the two guide wires 51 so as to maintain the rigidity of the lower portions of the guide wires 51 as well as to fix the lumbar support device LS to the seat back frame F2. The lower connecting portion 53 is made of plastic; the lower connecting portion 53 is produced through insert molding process, by which the guide wires 51 are integrated in the lower connecting portion 53. As described above, the laterally extending lower portion of the U-shaped guide wire 51 is retained inside the lower connecting portion 53.

As seen in FIG. 3, two projections 53A as an example of a lower restriction portion are formed on the rear surface of the lower connecting portion 53; the two projections 53A are laterally spaced apart from each other. The projections 53A are disposed at positions corresponding to the through-holes 14B of the seat back frame F2, and each of the projections 53A has a cylindrical configuration. The projections 53 are provided on the rear surface of the central portion 41 of the pressure-receiving plate 40 (see FIG. 1).

Further, fixing holes 53B that are arranged side by side are formed in the rear surface of the lower connecting portion 53; the fixing holes 53B are provided at positions slightly lower than and laterally inward of the projections 53A. The fixing holes 53B are holes into which screws 91 are screwed. Each of the fixing holes may optionally be provided with a thread groove.

The lower lifting plate 54 is movable in the upper-lower direction while being guided by the guide wires 51. The lower lifting plate 54 has a right end portion and a left end portion each including a guide portion 54A; the guide portions 54A are configured to form grooves engageable with the corresponding two guide wires 51, so that the guide portions 54A are engaged with the guide wires 51. A motor 56B of the support portion lifting mechanism 56 and a motor 57B of the arch deformation mechanism 57 are fixed to the rear surface of the lower lifting plate 54.

The upper lifting plate 55 is movable in the upper-lower direction while being guided by the guide wires 51. The upper lifting plate 55 is disposed above the lower lifting plate 54. The upper lifting plate 55 has a right end portion and a left end portion each including a guide portion 55A; the guide portions 55A are configured to form grooves engageable with the corresponding two guide wires 51, so that the guide portions 55A are engaged with the guide wires 51.

The support portion lifting mechanism 56 is a mechanism for raising and lowering the lower lifting plate 54 and the upper lifting plate 55 together. The support portion lifting mechanism 56 includes a screw shaft 56A, a motor 56B, a nut 56C, an upper end fixing portion 56D, and a lower end fixing portion 56E.

The screw shaft 56A is a rod extending long in the upper-lower direction and having an external thread formed on its outer peripheral surface.

The motor 56B includes an output shaft that is rotatable in forward and reverse directions under control of a controller (not shown).

The nut 56C is connected to the motor 56B by a gear mechanism (not shown) so that the forward or reverse rotation is selectively performed in accordance with the rotational direction of the motor 56B. The nut 56C is engaged with the screw shaft 56A, and can be moved upward or downward according to its rotation relative to the screw shaft 56A.

The upper end fixing portion 56D is provided at an upper end of the screw shaft 56A to fix the upper end of the screw shaft 56A to the rear surface of the upper connecting portion 52.

The lower end fixing portion 56E is provided at a lower end of the screw shaft 56A to fix the lower end of the screw shaft 56A to the rear surface of the lower connecting portion 53.

The arch deformation mechanism 57 is a mechanism for raising and lowering the upper lifting plate 55 relative to the lower lifting plate 54. The arch deformation mechanism 57 includes a screw shaft 57A, a motor 57B, a nut 57C, an upper end fixing portion 57D, and a cap 57E.

The screw shaft 57A is a rod extending long in the upper-lower direction and having an external thread formed on its outer peripheral surface.

The motor 57B includes an output shaft that is rotatable in forward and reverse directions under control of a controller (not shown).

The nut 57C is connected to the motor 57B by a gear mechanism (not shown) so that the forward or reverse rotation is selectively performed in accordance with the rotational direction of the motor 57B. The nut 57C is engaged with the screw shaft 57A, and can be moved upward or downward according to its rotation relative to the screw shaft 57A.

The upper end fixing portion 57D is provided at an upper end of the screw shaft 57A to fix the upper end of the screw shaft 57A to the rear surface of the upper lifting plate 55.

The cap 57E is provided at a lower end of the screw shaft 57A to prevent the lower end of the screw shaft 57A from getting caught in surrounding objects.

Returning to FIG. 2, each of the arching members 58 is a belt-shaped member extending long in the upper-lower direction, and is made, for example, from a metal plate having elasticity. The upper end of the arching member 58 is fixed to the front surface of the upper lifting plate 55 by a rivet or screw, and the lower end of the arching member 58 is fixed to the front surface of the lower lifting plate 54 by a rivet or screw. Two arching members 58 are arranged side by side at positions close to the right and left end portions of the lower lifting plate 54 and the upper lifting plate 55 and facing to the rear surface of the central portion 41 of the pressure-receiving plate 40.

As seen in FIG. 3, the support wires 59 are wires having a circular cross-section and extend upward from the right and left end portions of the upper connecting portion 52. The upper connecting portion 52 is produced through insert molding process, by which the two guide wires 51 are integrated in the upper connecting portion 52. Although not shown in the drawings, the two connecting wires 59 are connected together at their lower end portions to form a single U-shaped wire. An upper end portion of each of the support wires 59, specifically a contactable area at which the support wire 59 possibly contacts the edge of the support hole 15B, is coated with a resin with excellent sliding property such as nylon, to provide a coating portion 59A. Providing the coating portions 59A can abate noise which would be produced if the support wires 59 move upward or downward relative to the support holes 15B when the occupant applies a load to the seat back or removes the load from the seat back.

It should be noted that part of the above-described lumbar support device LS not including the support wires 59 and the projections 53A corresponds to a pressure-receiving member body.

The operation of the lumbar support device LS will now be described briefly.

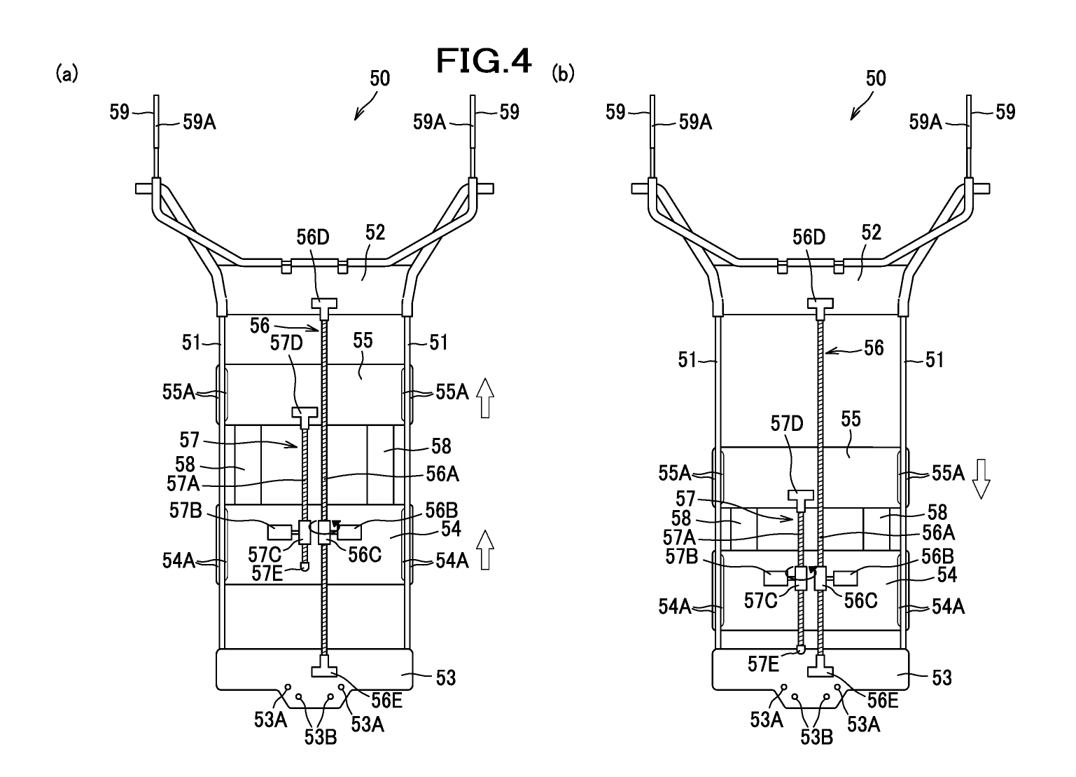

As seen in FIG. 4(a), the nut 56C moves relative to the screw shaft 56A when the output shaft of the motor 56B is rotated and the nut 56C is caused to rotate accordingly. For example, as seen in FIG. 4(a), when the nut 56C moves upward relative to the screw shaft 56A, the upper lifting plate 55 and the lower lifting plate 54 are caused to move upward together. At this time, the upper lifting plate 55 and the lower lifting plate 54 are guided by the guide wires 51, and slide on the guide wires 51.

As seen in FIG. 4(b), the nut 57C moves relative to the screw shaft 57A when the output shaft of the motor 57B is rotated and the nut 57C is caused to rotate accordingly. As the nut 57C is not allowed to move upward or downward relative to the lower lifting plate 54, the screw shaft 57A moves upward or downward when the nut 57C rotates. For example, as seen in FIG. 4(b), when the nut 57C is rotated and the screw shaft 57A moves downward, the upper lifting plate 55 moves downward relative to the lower lifting plate 54 according to the movement of the screw shaft 57A. At this time, the upper lifting plate 55 is guided by the guide wires 51, and slides on the guide wires 51.

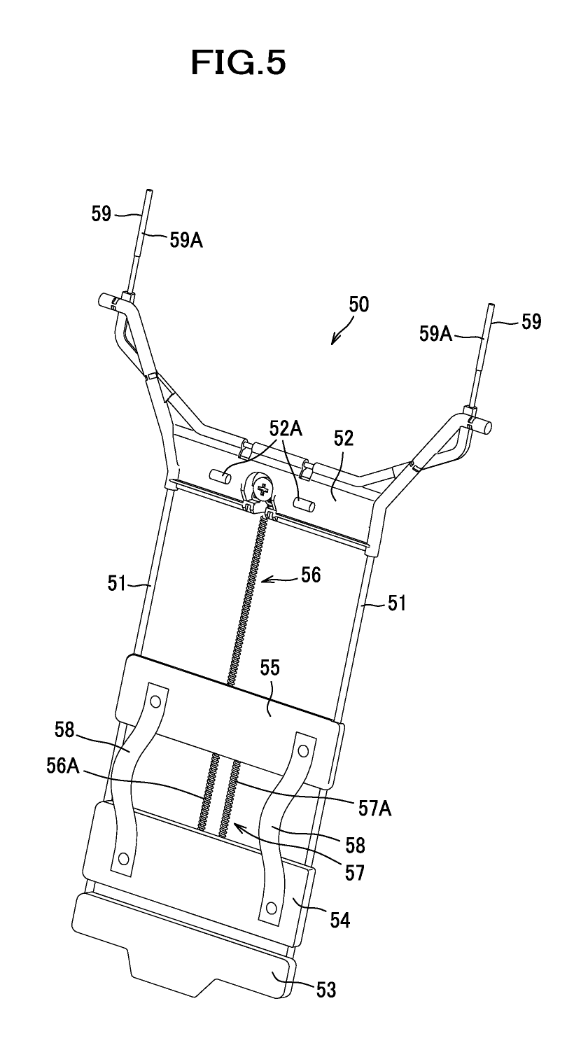

When the upper lifting plate 55 approaches the lower lifting plate 54 (see FIG. 4(b)), the arching members 58 are bowed frontward as seen in FIG. 5 because the arching members 58 have an extra length between the upper lifting plate 55 and the lower lifting plate 54. Accordingly, the front surfaces of the arching members 58 push the rear surface of the central portion 41 of the pressure-receiving plate 40, so that the central portion 41 deforms to protrude frontward in a bow shape. By rotating the motor 56B and the motor 57B forwardly or reversely, the amount of frontward protrusion of the pressure-receiving plate 40 and the vertical position of this frontward protrusion can be adjusted, so that the lumbar region of the occupant can be supported appropriately.

Next, the manner of attaching the lumbar support device LS to the seat back frame F2 will be described.

As seen in FIG. 6, the lumbar support device LS is placed under the bridge frame 15 and raised upward while the tip ends of the support wires 59 are aligned with the support holes 15B. After that, the support wires 59 are inserted into the support holes 15B. This makes it possible to restrict the front-rear position and the lateral position of the upper portion of the lumbar support device LS (i.e., pressure-receiving member body).

Next, as seen in FIG. 7, the projections 53A provided on the rear surface of the lower connecting portion 53 are inserted into the through-holes 14B from the front side and engaged with the through-holes 14B. This makes it possible to restrict the upper-lower position and the lateral position of the lower portion of the lumbar support device LS (i.e., pressure-receiving member body).

When the projections 53A are engaged with the through-holes 14B, the projections 53A rest on the lower edges of the through-holes 14B, so that the lumbar support device LS can be supported stably even if an assembly worker does not hold the lumbar support device LS with his/her hand. Especially, according to this embodiment, the plurality of projections 53A and the plurality of through-holes 14B are disposed laterally spaced apart from each other, so that the lumbar support device LS can be supported stably. Accordingly, assembly of the lumbar support device LS with the seat back frame F2 and positioning of the lumbar support device LS can be performed with ease, and thus excellent attachment workability can be achieved.

Then, screws 91 are inserted through the attachment holes 14A and fastened by screwing them into the fixing holes 53B. This makes it possible to secure the lower portion of the lumbar support device LS (i.e., pressure-receiving member body) to the seat back frame F2. When fastening the screws 91, the screws 91 are engaged with the seat back frame F2 and the lumbar support device LS in the rearward-to-frontward direction that is opposite to the direction in which the projections 53A have entered the through-holes 14B. Therefore, the assembly worker can perform the fastening operation while visually checking whether the projections 53A have been properly engaged in the through-holes 14B.

When the lumbar support device LS is fixed to the seat back frame F2 using the screws 91, the screws 91 are disposed below the projections 53A. The projections 53A are disposed above and on both sides of the screws 91.

According to the car seat S in this embodiment, the lumbar support device LS is not fixed to the side frames 11 in a suspended manner, but is supported by the lower frame 14 and the bridge frame 15 that connect the right and left side frames 11. Therefore, other parts can be attached to the side frames 11, so that improved space efficiency of the narrow seat back is ensured.

Although one preferred embodiment of the present invention has been described above, the present invention is not limited to the above-described embodiment. It is to be understood that various changes and modifications may be made to any of the specific configurations where necessary without departing from the gist of the present invention.

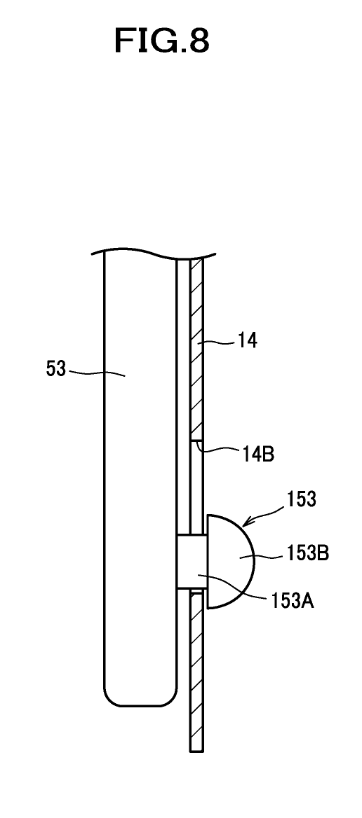

For example, as shown in a modification of FIG. 8, projections 153 are provided as an example of a lower restriction portion. Each of the projections 153 may include a base portion 153A resting on the edge of the through-hole 14B, and a large-diameter portion 153B provided distally farther than the base portion 153A and having a diameter larger than that of the base portion 153A. The large-diameter portion 153B has a diameter smaller than that of the through-hole 14B so that the large-diameter portion 153B can be inserted through the through-hole 14B. According to the example of FIG. 8, the large-diameter portion 153B is enlarged at its upper portion and lower portion with respect to the base portion 153A. However, the large-diameter portion 153B may be enlarged at least at its lower portion and extend downward. In other words, in the example of FIG. 8, the protrusion 153 may have an L-shaped distal end extending downward.

With this configuration, the base portion 153A rests on the lower edge of the through-hole 14B and the large-diameter portion 153B engages with the edge of the through-hole 14B, so that the protrusion 153 is prevented from coming off frontward from the through-hole 14B and the assembling workability of the lumbar support device LS can be improved further.

Further, in the above-described embodiment, the lumbar support device LS has been illustrated as an example of a pressure-receiving member. However, the pressure-receiving member may be a simple pressure-receiving plate without the function of changing the shape of a portion of the pressure-receiving plate around the lumbar region of the occupant.

In the above-described embodiment, the support holes 15B are formed in the bridge frame 15. However, the support holes may be formed in the upper portions of the side frames 11.

Further, in the above-described embodiment, the engagement portion is formed in the lower frame 14. However, the engagement portion may be formed in the lower portions of the side frames 11.

The above-described embodiment has been illustrated as an example in which the present invention is applied to a seat used in an automobile (i.e., car seat S) as a vehicle seat. However, the present invention is not limited thereto, and applicable to any other seat used in other vehicles, such as rail cars, aircraft and ships.

1. A vehicle seat comprising:
a seat back frame; and
a pressure-receiving member supported by the seat back frame, the pressure-receiving member including a pressure-receiving plate configured to receive a load from a back of an occupant,
wherein the seat back frame includes a support hole disposed at an upper part of the seat back frame and extending through in an upper-lower direction, and an engagement portion disposed at a lower part of the seat back frame, and
wherein the pressure-receiving member includes a pressure-receiving member body including the pressure-receiving plate, an upper restriction portion disposed at an upper part of the pressure-receiving member body and inserted through the support hole to restrict a front-rear position and a lateral position of an upper portion of the pressure-receiving member body, and a lower restriction portion disposed at a lower part of the pressure-receiving member body and engaged with the engagement portion to restrict an upper-lower position and a lateral position of a lower portion of the pressure-receiving member body.

2. The vehicle seat according to claim 1, wherein the seat back frame includes side frames spaced apart from each other in a lateral direction, and a connecting member connecting lower portions of the side frames, and
wherein the engagement portion is disposed in the connecting member.

3. The vehicle seat according to claim 1, wherein the seat back frame includes side frames spaced apart from each other in a lateral direction, and a bridge member connecting upper portions of the side frames, and
wherein the support hole is formed in the bridge member.

4. The vehicle seat according to claim 1, wherein the engagement portion is provided at plural positions, and a plurality of engagement portions are spaced apart from one another, and
wherein the lower restricting portion is provided at plural positions corresponding to the plurality of engagement portions, and a plurality of lower restricting portions are spaced apart from one another.

5. The vehicle seat according to claim 1, wherein the engagement portion is a through-hole formed in the seat back frame and extending though the seat back frame in a front-rear direction, and
wherein the lower restriction portion is a projection engageable with the through-hole.

6. The vehicle seat according to claim 5, further comprising a fixing member configured to fix the lower part of the pressure-receiving member body to the lower part of the seat back frame.

7. The vehicle seat according to claim 6, wherein the fixing member is engaged with the seat back frame and the pressure-receiving member from a direction opposite to a direction in which the lower restriction portion enters the engagement portion.

8. The vehicle seat according to claim 6, wherein the fixing member is disposed below the lower restriction portion.

9. The vehicle seat according to claim 1, wherein the pressure-receiving plate includes a central portion, and a pair of side portions disposed on right and left sides of the central portion and protruding frontward farther than the central portion, and
wherein the lower restriction portion is disposed at a rear side of the central portion.

10. The vehicle seat according to claim 5, wherein the lower restriction portion includes at a distal end thereof a wide diameter portion having a diameter larger than that of a base portion, the wide diameter portion being engaged with an edge of the through-hole.
